(19) United States
(12) Patent Application Publication
(10) Pub. No.: US 2008/0275904 A1
(43) Pub. Date: Nov. 6, 2008

(54) Method of Generating and Methods of Filtering a User Profile

(75) Inventors: Dirk Jeroen Breebaart, Eindhoven (NL); Martin Franciscus McKinney, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/093,461

(22) PCT Filed: Oct. 27, 2006
(86) PCT No.: PCT/IB06/53977

§ 371 Date: May 13, 2008

(30) Foreign Application Priority Data
Nov. 16, 2005 (EP) 05110802.5

(51) Int. Cl. G06F 7/00; G06F 17/30

(52) U.S. Cl. 707/102; 707/E17.009

(57) ABSTRACT

A method of generating a user profile (7;17,19;29) of a user of a device (14,15;23-26) for processing data representative of items of content, a respective recording of at least one perceptible content element being associated with each item of content, includes determining a set (3) containing a plurality of recordings of at least one perceptible content element, each associated with one of a plurality of items of content associated with the user, and generating data representative of a user profile (7;17,19;29) associating preferences of the user with the user, wherein the data representative of the user profile (7;17,19;29) includes one or more parameter values within an at least one-dimensional feature space, each dimension representing a property of at least a section of a recording of at perceptible content element, such that at least one of the dimensions in the feature space represents a quantifiable property of at least a section of a perceptible content element. At least one set of parameter values, each set containing at least one parameter value and quantifying a dimension of the feature space in the user profile (7;17,19;29), is obtained by applying a pre-determined analysis algorithm to each of a plurality of signals, each signal representing at least a section of a recording of at least one perceptible content element, such that the set of parameter values is based on a plurality of the recordings in the set of recordings.

The invention relates to a method of generating a user profile of a user of a device for processing data representative of items of content, a respective recording of at least one perceptible content element being associated with each item of content, including

determining a set containing a plurality of recordings of at least one perceptible content element, each associated with one of a plurality of items of content associated with the user, and

generating data representative of a user profile indicating preferences of the user, wherein the data representative of the user profile includes one or more parameter values within an at least one-dimensional feature space, each dimension representing a property of at least a section of a recording of a perceptible content element, such that at least one of the dimensions in the feature space represents a quantifiable property of at least a section of a recording of a perceptible content element.

The invention also relates to a method of filtering a user profile of a user of a device for processing data representative of items of content, a respective recording of at least one perceptible content element being associated with each item of content, including

determining a set containing at least one recording of at least one perceptible content element, respectively associated with items of content associated with the user,

generating data representative of a user profile indicating preferences of the user, wherein the data representative of the user profile includes one or more parameter values within an at least one-dimensional feature space, each dimension representing a property of at least a section of a recording of a perceptible content element, such that at least one of the dimensions in the feature space represents a quantifiable property of at least a section of a recording of a perceptible content element, and transmitting the data representative of the user profile to a second device arranged to determine, using a similarity metric, whether any of one or more further profiles including a set of one or more parameter values within the feature space match the user profile.

The invention also relates to a method of filtering a user profile expressing preferences of a user of a device for processing data representative of items of content having respective recordings of perceptible content elements associated with them, including generating data representative of a user profile indicating preferences of the user, wherein the data representative of the user profile includes one or more parameter values within an at least one-dimensional feature space, each dimension representing a property of at least a section of a recording of a perceptible content element, such that at least one of the dimensions in the feature space represents a quantifiable property of at least a section of a recording of a perceptible content element, and determining, using a similarity metric, whether any of one or more further profiles including a set of one or more parameter values within the feature space match the user profile.

The invention also relates to a method of filtering a user profile expressing preferences of a user of a device for processing data representative of items of content having respective recordings of perceptible content elements associated with them, wherein

a second device receives from the device through a data link data representative of a user profile indicating preferences of the user, wherein the data representative of the user profile includes one or more parameter values within an at least one-dimensional feature space, each dimension representing a property of at least a section of a recording of a perceptible content element, wherein at least one of the dimensions in the feature space represents a quantifiable property of at least a section of a recording of a perceptible content element, and wherein

the second device retrieves one or more further profiles including a set of one or more parameter values within the feature space and determines, using a similarity metric, whether any of the retrieved profiles matches the user profile.

The invention also relates to a system for generating a user profile, configured to execute a method of generating a user profile according to the invention.

The invention also relates to a system for filtering a user profile, configured to execute a method of filtering a user profile according to the invention.

The invention also relates to a computer program.

In U.S. Pat. No. 6,545,209, systems and methods are described that associate closely related and/or similarly situated media entities with each other using inherent media entity characteristics. The songs from a database are classified according to digital signal processing techniques. Exemplary classifications for songs include, inter alia, tempo, sonic, melodic movement and musical consonance characterisations. The quantitative machine classification and qualitative human classifications for a given piece of media are placed into what is referred to as a classification chain. The technique maps a pre-defined parameter space to a psychoacoustic perceptual space defined by musical experts. This mapping enables content-based searching of media. Playlists may be generated, for example, from a single song and/or a user preference profile in accordance with an appropriate analysis and matching algorithm performed on the data store of the database. Nearest neighbour and/or other matching algorithms may be utilised to locate songs that are similar to the single song and/or are suited to the user profile. In the case of a song as input, first, a DSP analysis of the input song is performed to determine the attributes, qualities, likelihood of success, etc. of the song.

A problem of the known technique is that a user with a broad taste requiring a playlist matching the entire spectrum of his or her preferences, must either submit a plurality of songs to generate a plurality of playlists, or must resort to the less precise method of submitting a user profile describing subjective aspects of his or her preferred songs. The former is relatively inefficient, whereas the latter option may require repeated attempts, due to the inherent inaccuracy in classifying favourite songs according to subjective aspects.

It is an object of the invention to provide a method of generating a user profile and methods of filtering a user profile, as well as corresponding systems and a computer program, of the types mentioned above, that permit relatively accurate and efficient filtering.

This object is achieved according to one aspect by the method of generating a user profile according to the invention, which is characterised in that at least one set of parameter values, each set containing at least one parameter value and quantifying a dimension of the feature space in the user profile, is obtained by applying a pre-determined analysis algorithm to each of a plurality of signals, each signal representing at least a section of a recording of at least one perceptible content element, such that the set of parameter values is based on a plurality of the recordings in the set of recordings.

Because the at least one set of parameter values is obtained by applying an analysis algorithm to each of the signals representing at least sections of the recordings of at least one perceptible content element, an objective measure of at least one property of the recording is obtained. Because the analysis algorithm is pre-determined, comparisons with parameter values generated by another entity using the same algorithm can accurately and predictably identify recordings or sets of recordings with similar properties to those on which the set of parameter values is based. Because the analysis is applied to each of a plurality of signals, such that the set of parameter values is based on a plurality of the recordings in a set of recordings associated with the user, the preferences of the user as expressed in the generated user profile are based on several preferred recordings of at least one perceptible content element. Thus, when such a user profile is filtered, i.e. matched against profiles characterising other users' preferences or characterising other recordings of a perceptible content element, it is avoided that the result is based on a recording that is an anomaly within the spectrum of the user's tastes. In the present context, a perceptible content element is assumed to be one of a sound or visual element of audiovisual content comprising either one or both of such elements. Examples include the audio track in a music file, the audio track accompanying a movie, a sequence of images in a movie, the visual information in a picture file, etc.

In an embodiment, the data representative of the user profile includes data representative of the distribution over the plurality of recordings in the set of recordings of parameter values obtained by applying the pre-determined analysis algorithm to the signals representing at least sections of the respective recordings.

Thus, the user profile becomes suitable for indicating the extent of the user's taste with respect to the content. It becomes more accurate, allowing for better and thus faster searching for other users' tastes or for recordings of perceptible content elements or content items matching the preferences expressed in the user profile.

An embodiment includes applying a clustering algorithm to the parameter values obtained by applying the pre-determined analysis algorithm to the signals representing at least sections of the respective recordings, and including in the data representative of the user profile data indicating the position of the clusters along at least one quantified dimension of the feature space.

In an embodiment, the data representative of the user profile includes data indicating the strength of each cluster.

Thus, the significance of overlaps between clusters identified in two different user profiles can be assessed. Where, for example, of two clusters in a first user profile, one overlaps with a cluster indicated in a second user profile and one overlaps with a cluster indicated in a third user profile, the matches between the first and second and between the first and third user profile can be ranked.

In an embodiment the data representative of the user profile includes data indicating the spread of each cluster along at least one quantified dimension of the feature space.

This is useful to determine whether a particular preference of the user is marked or not. The similarity metric can advantageously be based on the area of overlap between clusters identified in different user profiles, rather than relying only on distances between the centres of clusters.

In an embodiment, at least one further set of parameter values, each set containing at least one parameter value and quantifying at least one further dimension of the feature space, is obtained by applying at least one pre-determined analysis algorithm to each of a plurality of signals, each signal representing at least a section of a recording of at least one perceptible content element in the set of recordings,

at least one measure of a correlation between parameter values quantifying different dimensions of the feature space is determined, and

data representative of the determined measures is included among the data representative of the user profile.

This embodiment thus determines relations between dimensions. This is useful for identifying particular styles characterised by such a relation. The user profile and/or comparison of the user profile may also be made more efficient in cases where there is a marked relation between two dimensions. Data quantifying one of the two may be omitted from the user profile or comparison.

An embodiment of the method includes determining the items of content associated with the user on the basis of a user's selection of the items of content for processing by the user device.

Such an implicit selection makes the method unobtrusive and efficient, since separate selection options need not be provided in the user device.

According to another aspect of the invention a method of filtering a user profile of a user of a device for processing data representative of items of content, a respective recording of at least one perceptible element being associated with each item of content, is provided. The method includes

determining a set containing at least one recording of at least one perceptible content element, respectively associated with a user's favourite items of content associated with the user,

generating data representative of a user profile indicating preferences of the user, wherein the data representative of the user profile includes one or more parameter values within an at least one-dimensional feature space, each dimension representing a property of at least a section of a recording of a perceptible content element, such that at least one of the dimensions in the feature space represents a quantifiable property of at least a section of a recording of a perceptible content element, and transmitting the data representative of the user profile to a second device arranged to determine, using a similarity metric, whether any of one or more further profiles including a set of one or more parameter values within the feature space match the user profile, and is characterised in that

at least one set of at least one parameter value quantifying a dimension of the feature space in the user profile is obtained by applying a pre-determined analysis algorithm to at least one signal representing at least a section of a recording of at least one perceptible content element in the set of audio tracks.

Because at least one set of at least one parameter value quantifying a dimension of the feature space in the user profile is obtained by applying an analysis algorithm to at least one signal representing at least a section of a recording of at least one perceptible content element in the set of recordings, an objective measure of at least one property of the recording of at least one perceptible content element is obtained. Because the analysis algorithm is pre-determined, comparisons with parameter values generated by another entity using the same algorithm can accurately and predictably identify recordings or sets of recordings with similar properties to those of the recordings on which the set of parameter values is based. Because the set of at least one parameter value is included in the data representative of the user profile, and is transmitted to a second device, the method is more efficient than would be the case if the entire section of the recording were to be transmitted. Due to the increased accuracy and objective nature of the parameter values, the likelihood of a good match at the first try is increased, decreasing the amount of data exchanged between the user's device and the second device.

According to another aspect of the invention, a method of filtering a user profile expressing preferences of a user of a device for processing data representative of items of content having respective recordings of at least one perceptible content element associated with them is provided, including

generating data representative of a user profile associating preferences of the user with the user, wherein the data representative of the user profile includes one or more parameter values within an at least one-dimensional feature space, each dimension representing a property of at least a section of a recording of a perceptible content element, such that at least one of the dimensions in the feature space represents a quantifiable property of at least a section of a recording of a perceptible content element, and determining, using a similarity metric, whether any of one or more further profiles including a set of one or more parameter values within the feature space match the user profile, wherein the data representative of the user profile is generated by applying a method of generating a user profile according to the invention.

According to another aspect of the invention, a method of filtering a user profile expressing preferences of a user of a device for processing data representative of items of content having respective recordings of at least one perceptible content element associated with them is provided, wherein

a second device receives from the device through a data link data representative of a user profile associating preferences of the user with the user, wherein the data representative of the user profile includes one or more parameter values within an at least one-dimensional feature space, each dimension representing a property of at least a section of a recording of a perceptible content element, wherein at least one of the dimensions in the feature space represents a quantifiable property of at least a section of a recording of a perceptible content element, and wherein

the second device retrieves one or more further profiles including a set of one or more parameter values within the feature space and determines, using a similarity metric, whether any of the retrieved profiles matches the user profile, characterised in that the second device receives and determines whether any of the retrieved profiles matches a user profile in which at least one of the parameter values is obtainable by applying a pre-determined analysis algorithm to at least one signal representing at least a section of a recording in the set of recordings.

Because at least one set of at least one parameter value quantifying a dimension of the feature space in the user profile is obtained by applying an analysis algorithm to at least one signal representing at least a section of a recording of a perceptible content element in the set of recordings, an objective measure of at least one property of the recording is obtained. Because the analysis algorithm is pre-determined, comparisons with parameter values generated by another entity using the same algorithm can accurately and predictably identify recordings or sets of recordings with similar properties to those on which the set of parameter values is based. Because the set of at least one parameter value is included in the data representative of the user profile, and is received and used to determine matching profiles, the method is more efficient than would be the case if the entire section of the recording were to be received and then analysed. Due to the increased accuracy and objective nature of the parameter values, the likelihood of a good match at the first try is increased, decreasing the amount of data received and processed by the second device.

An embodiment, wherein the further profiles are formed by further user profiles, each expressing the preferences of a further user of a device for processing data representative of items of content having respective recordings of at least one perceptible content element associated with them, includes identifying further users having a further user profile matching the user profile.

Thus, an efficient and accurate way of matching users with similar tastes is provided, which does not rely only on subjective descriptions of the users' tastes as provided by them.

An embodiment includes, for each further user having a further user profile matching the user profile, retrieving a list of content items selected by that further user, and

generating a list of recommended content items for the user, wherein the recommended content items are selected from the retrieved lists of content items.

Thus, an efficient, accurate and more effective way of collaborative filtering is provided. The method is efficient and accurate, because it is based on a comparison of parameter values obtainable by applying a pre-determined analysis algorithm to recordings associated with the respective users. It is more effective than conventional collaborative filtering methods, because it does not rely only on an identification of the items of content that have been selected by several users. Thus, the items selected by users with similar tastes to the target user but who have no selected item of content in common with the target user are also considered for recommendation to the target user. Because the method does not rely only on subjective rankings provided by the users, the recommendations are more accurately tuned to the target user's tastes.

According to another aspect of the invention, the system for generating a user profile is configured to execute a method of generating a user profile according to the invention.

According to another aspect of the invention, the system for filtering a user profile is configured to execute a method of filtering a user profile according to the invention.

According to another aspect of the invention, there is provided a computer program including a set of instructions capable, when incorporated in a machine-readable medium, of causing a system having information processing capabilities to perform a method according to the invention.

The invention will now be explained in further detail with reference to the accompanying drawings, in which:

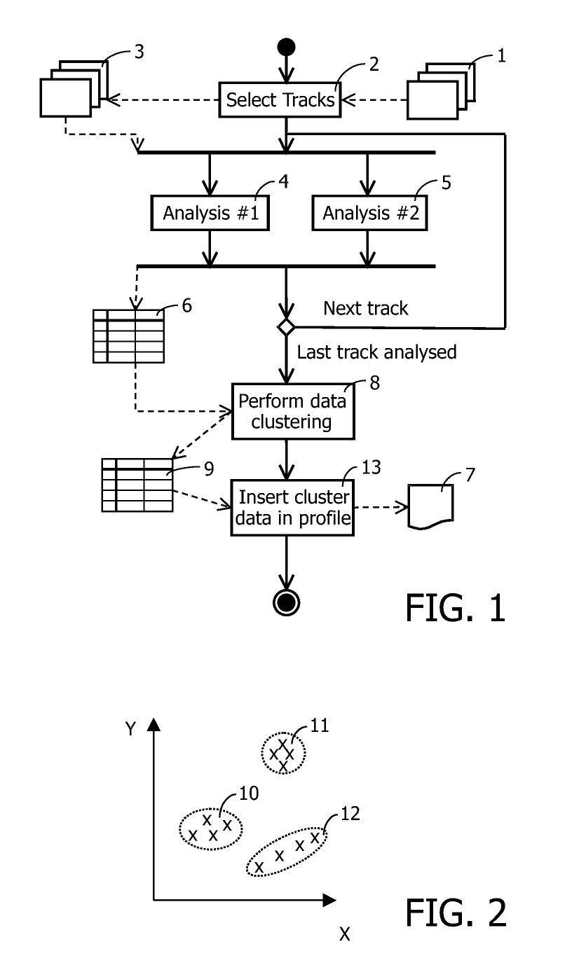

FIG. 1 outlines a method of generating a user profile;

FIG. 2 illustrates schematically the concept of data clustering in a two-dimensional feature space;

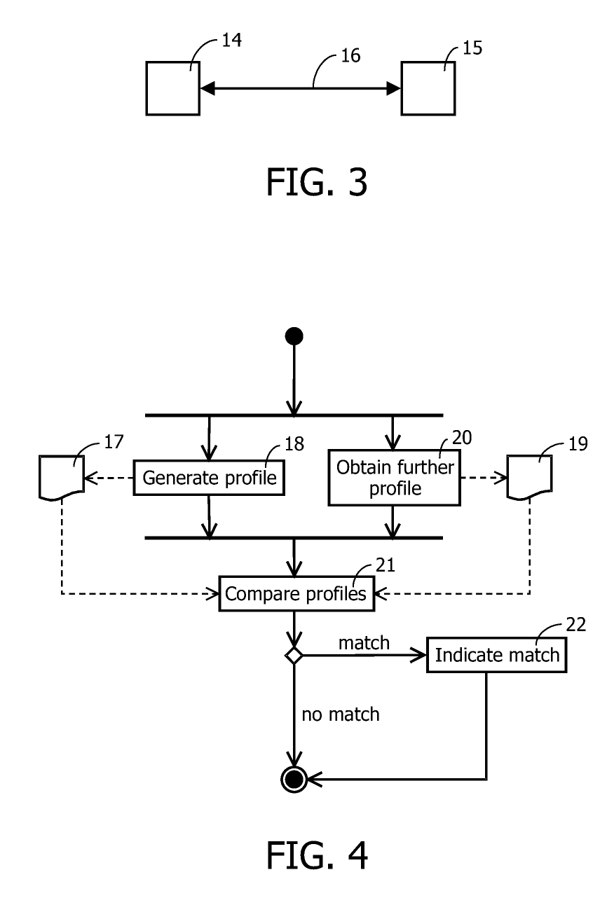

FIG. 3 illustrates schematically a first system for filtering a user profile;

FIG. 4 illustrates schematically a method of filtering a user profile as applicable in the system of FIG. 3;

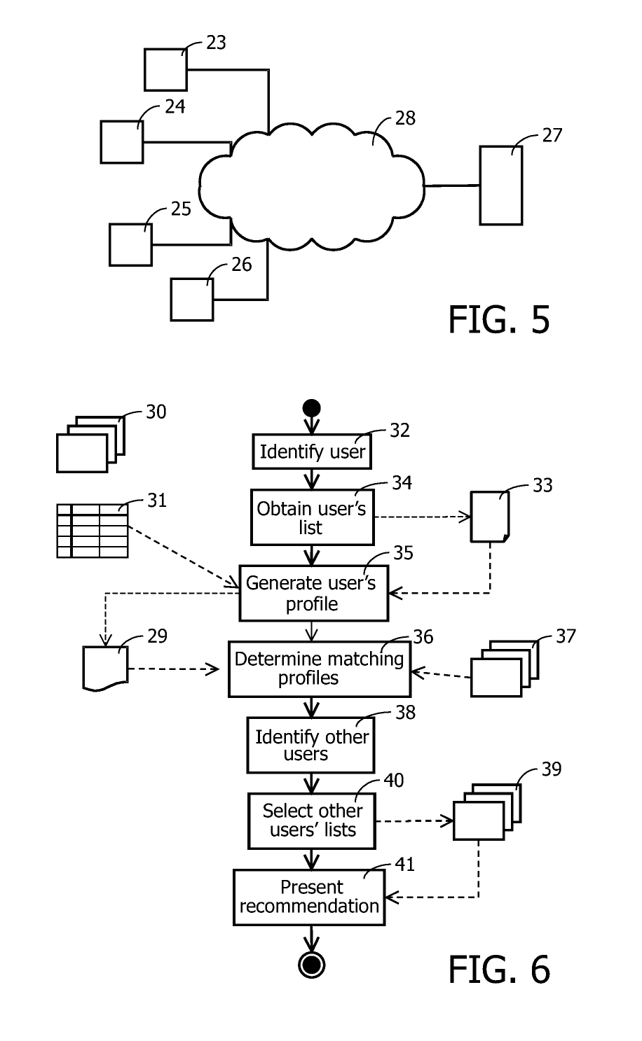

FIG. 5 illustrates schematically a system for collaborative filtering;

FIG. 6 illustrates schematically a method of collaborative filtering using methods of generating and filtering a user profile.

The methods outlined herein find application in all situations where it is desirable to express the musical tastes of one or more persons in an efficient and accurate manner. It is especially useful where this expression of musical tastes is to be communicated between devices. Although the methods employed differ slightly per application, the generation of a user profile is common to all applications.

In the following, an example will be described wherein the user profile is based on audio tracks, and usable to find audio tracks matching the tastes expressed in the user profile. However, the user profile could also be used to express preferences for items of content of a different type but having audio tracks associated with them. An example would be a video file, wherein the audio track expresses particular moods. The principles of the method are also applicable where a type of recording of a perceptible content element other than an audio track is analysed.

The method illustrated in FIG. 1 is advantageously executed by a system for rendering the item of content, e.g. the audio track. In particular, the method is advantageously executed in a small form-factor mobile music player. Such a device can have a large database of audio tracks, stored in a magnetic disk drive or a solid state memory device, but limited capacity to manoeuvre through all the songs. Especially where the device is equipped with a communication port, for example a port for establishing a connection to the Internet, the compact and accurate user profile obtained by means of the method of FIG. 1 is easily shared between devices. This is, of course, even truer in implementations in which a mobile music player is integrated in a device such as a cellular telephone.

The method illustrated in FIG. 1 is based on a database 1 of audio tracks. The audio tracks either form the items of content designated herein, or are associated with respective items of content in some other way, for example by being the audio track in video files. In a first step 2, a plurality of audio tracks in the database 1 is selected, to form a set 3 of selected audio tracks. Selection may be explicit or implicit. An example of the latter, preferred variant is where those audio tracks are selected that have been rendered most often or most recently.

A feature vector (not shown) is generated (steps 4,5) for each of the audio tracks in the set 3. The feature vector contains a number of elements, each consisting of a parameter value that quantifies a dimension of a multi-dimensional feature space. The multi-dimensional feature space describes perceptually important properties of an audio track. Each value in the feature vector associated with a particular audio track is obtained by applying a pre-determined analysis algorithm to a signal representing at least a section of that particular audio track. In certain embodiments, several signals, each based on a different section of the audio track are analysed, so that different values in the feature vector relate to different sections.

The use of a computational method based on a pre-determined analysis algorithm ensures that the feature vector is an objective characterisation of perceptual properties of at least a section of the audio track concerned. It is more compact than the entire set of data encoding the audio track. Depending on the implementation, the analysis algorithm may take PCM (Pulse-code Modulation) values, DCT (Direct Cosine Transform) coefficients or any other convenient form of encoded audio file as input.

Suitable analysis algorithms for quantifying perceptually important properties of an audio track are known as such. For this reason, they are not described in any great detail herein. One example is described in Klapuri et al., “Analysis of the Meter of Acoustic Musical Signals”, IEEE Trans. Speech and Audio Proc. This article describes a method which analyses the meter of acoustic musical signals at the tactus, tatum and measure levels, which correspond to different time scales. The result can be used, for example, to identify the genre of music (classical, jazz, etc.). Another example of an algorithm that can be used in one of steps 4,5 is presented in Scheirer, E. D., “Tempo and beat analysis of acoustic musical signals”, J. Acoust. Soc. Am. 103 (1), January 1998. A further possibility is to model an audio track or section of an audio track using Mel Frequency Cepstral Coefficients, as employed also in speech recognition algorithms.

In FIG. 1, the feature vectors are entered into a table 6, with an entry for each audio track. In the example, a feature vector represents a point in a feature space that is two-dimensional, since the results of two analysis algorithms are incorporated into the vector. Where several sections of one audio track are analysed, a feature vector may represent more than one point in the two-dimensional feature space. It is noted that a two-dimensional feature space is used herein as an example for ease of representation. In practical implementations, a higher number of perceptual properties of audio tracks may be quantified.

In a simple implementation, a user profile is generated on the basis of only one audio track, termed a seed song. This user profile can be transferred from a first device to a second device arranged to determine, using a similarity metric, whether any of one or more further feature vectors including parameter values determining a point in the same multi-dimensional feature space, match the user profile generated from the seed song. A distance metric is used for this purpose. One useful application, for example, is to determine whether another mobile music player has further audio tracks by the same artist stored therein, in the absence of tags identifying the audio tracks as being by that artist. Another useful application is to compile collections of audio tracks that capture a particular mood.

In the example illustrated in FIG. 1, a user profile 7 is generated that is more suitable for expressing the full spectrum of a user's musical preferences. In particular, the user profile 7 is based on the totality of audio tracks in the set 3 of selected audio tracks. It includes data representative of the distribution over the audio tracks in the set 3 of parameter values that were obtained in the analysis steps 4,5. The feature vectors generated in steps 4,5 and represented in the table 6 are clustered (step 8) using a data clustering algorithm.

Data clustering algorithms are known as such. The term refers to a partitioning of a data set into subsets (clusters) such that the data in each subset share some common trait, in particular proximity according to a pre-defined distance measure. Two types of data clustering exist and are suitable for implementing the step 8 illustrated in FIG. 1: hierarchical clustering and partitional clustering. Hierarchical clustering methods include divisive algorithms and agglomerative algorithms. Agglomerative clustering algorithms build clusters by progressively merging clusters. Each agglomeration occurs at a greater distance between clusters. Clustering stops when a distance criterion between clusters has been met or when there is a sufficiently small number of clusters. Examples of partitional clustering include k-means algorithms, QT Clust algorithms and Fuzzy c-means clustering. A particularly suitable algorithm for implementing the clustering step 8 is described in Figueiredo, M. A. T. et al., “On Fitting Mixture Models”, in Hancock, E. and Pellilo, M. (Eds.), Energy Minimization Methods in Computer Vision and Pattern Recognition, pp. 54-69, Springer, 1999. This is an example of an agglomerative clustering algorithm.

Considering FIG. 2 as an example, crosses mark different points in a two-dimensional feature space, having the dimensions X and Y. Each point is associated with a feature vector. The clustering algorithm results in a table 9 (FIG. 1) identifying clusters 10-12 (FIG. 2) of feature vectors. The clusters 10-12 are suitably identified in the table 9 by means of a pair of co-ordinates (xᵢ,yᵢ) and a value rᵢ indicating the extent of the i-th cluster within the two dimensional feature space. Alternatively, the clusters may be represented by a value xᵢ with a standard deviation Δxᵢ and a value yᵢ with a standard deviation Δyᵢ. Thus, data indicating the spread of each cluster along at least one quantified dimension X,Y of the feature space is included in the table 9 identifying the clusters, in addition to data indicating the position of each cluster 10-12. The effect of including data indicating the spread of each cluster 10-12 within the feature space, is to indicate how marked the preference of a particular user is. In this respect, it is advantageous to quantify the spread along each dimension separately, because this captures, for example, a marked preference for a particular tempo regardless of the dynamics of a particular audio track.

Preferably, data indicating the strength of each cluster 10-12 is also included in the table 9 identifying the clusters 10-12. This could be a normalised count of the number of feature vectors in the cluster, for example. Clustering has the effect of separately identifying disparate preferences. Such information is lost if only an average of all feature vectors is taken. By also indicating the strengths of each cluster, a ranking between different styles, artists, genres, etc. can be made. This is especially useful where the selection in step 2 is an implicit selection. If a user selects predominantly rock music and occasionally classical music, then this will be indicated in the user profile 7, which is generated by inserting data corresponding to some or all of the entries in the table 8 identifying the clusters 10-12 into the user profile 7 (step 13).

It is also useful to determine at least one measure of a correlation between parameter values quantifying the different dimensions X,Y of the feature space, so that data representative of the determined measures can be included among the data representative of the user profile 7. Preferably, a measure of a correlation is determined separately for each of the clusters 10-12, and added to the data indicating the position of the clusters. It will be apparent that the correlation is much stronger for a third cluster 12 than for the first two clusters 10-11. Thus, the measure of the correlation serves to characterise the clusters 10-12. Such a strong correlation could server to identify a particular musical style, and thus a user's preference for this style.

The user profile 7 further contains data suitable for identifying the user who has been profiled, so that the user is associated with the properties of the audio tracks in the set 3 of selected audio tracks. Besides parameter values quantifying a measurable property of an audio track, the user profile 7 will in some embodiments also include subjective information as provided by the user.

A use of the user profile 7 is illustrated in FIGS. 3 and 4. A first mobile music player 14 is connected to a second mobile music player 15 via a communications link 16. The communications link 16 is advantageously a link in a personal area network or local area network, for example a wireless link. In this application it is determined whether the preferences of the user of the first mobile music player 14 match those of a user of the second mobile music player 15.

First, a user profile 17 of the user of the first mobile music player 14 is generated in a step 18, and a user profile 19 of the user of the second mobile music player 15 is obtained through the communications link 16 in a further step 20. The second mobile music player 15 is configured to generate the user profile 19 in a step similar to the step 18 executed by the first mobile music player 14. The step 18 of generating the user profile 17 is implemented using the method illustrated in FIG. 1. In a subsequent step 21, the two user profiles 17,19 are compared, using a distance metric, to determine whether they match. For example, the area of overlap of the clusters identified in the user profiles 17,19 may be determined. With a pre-determined overlap percentage being a criterion for determining a match. If the user profiles match according to this criterion, this is indicated (step 22) on an output device of either or both of the first and second mobile music players 14,15. The users may subsequently decide to share part or all of their database of audio tracks.

An application of user profiles in a system for collaborative filtering is illustrated in FIGS. 5 and 6. First to fourth music players 23-26 are connected to a server system 27 implementing a music download service. The connection is through a network 28, preferably a Wide Area Network such as the Internet.

The server system 27 implements a method of filtering a user profile 29. In the illustrated embodiment, the server system 27 generates the user profile 29. In variants, the music players 23-26 may generate user profiles for their respective users and transmit them to the server system 27 for filtering.

The method of FIG. 6 is used to provide a recommendation system. The server system 27 has available for download a database 30 of audio files. It also has a database 31 of feature vectors, for example one for each audio track represented in the database 30.

In a first step 32, the user requesting a recommendation is identified. A list 33 identifying the audio tracks previously selected for download by the user is then obtained (step 34).

In a subsequent step 35, the user profile 29 is generated on the basis of the feature vectors obtained by applying analysis algorithms to the audio tracks identified in the list 33. Those feature vectors are clustered to generate the user profile 29. The user profile 29 is then compared (step 36) to each of a set 37 of user profiles for representing the preferences of users of other ones of the music players 23-26.

The users for whom the matching user profiles have been generated are then identified (step 38), and lists 39 of audio files previously downloaded by them are selected (step 40). From these lists 39, a recommendation is made (step 41) for the user identified in the first step 32 (the target user). For example, the audio track appearing most often in the lists 39 may be suggested to the target user.

The effect of using the user profile 29 to identify other users with the same tastes and thence the lists 39 of audio files, is that a more consistent and precise match is obtained. Using a pre-determined analysis algorithm results in far less subjectivity across tracks and different collections of tracks, and will result in more consistent recommendations and comparisons. Because the dimensions in the feature space represent a quantifiable property of at least a section of an audio track, it is easier to calculate degrees of similarity between users' preferences. Also, a representation in terms of parameter values is relatively compact, at least more compact than the use of labels attached to the tracks by users. This in turn makes sharing of the data representative of the user profiles across different devices feasible.

It should be noted that the above-mentioned embodiments illustrate, rather than limit, the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The mere fact that certain measures are recited in mutually different dependent claims does not indicate that a combination of these measures cannot be used to advantage.

For instance, the set 37 of user profiles illustrated in FIG. 6 may be obtained by querying the music players 23-26, rather than being generated by the server system 27.

1. Method of generating a user profile (7;17,19;29) of a user of a device (14,15;23-26) for processing data representative of items of content, a respective recording of at least one perceptible content element being associated with each item of content, including
determining a set (3) containing a plurality of recordings of at least one perceptible content element, each associated with one of a plurality of items of content associated with the user, and
generating data representative of a user profile (7;17,19;29) indicating preferences of the user, wherein the data representative of the user profile (7;17,19;29) includes one or more parameter values within an at least one-dimensional feature space, each dimension representing a property of at least a section of a recording of a perceptible content element, such that at least one of the dimensions in the feature space represents a quantifiable property of at least a section of a recording of a perceptible content element, characterised in that
at least one set of parameter values, each set containing at least one parameter value and quantifying a dimension of the feature space in the user profile (7;17,19;29), is obtained by applying a pre-determined analysis algorithm to each of a plurality of signals, each signal representing at least a section of a recording of at least one perceptible content element, such that the set of parameter values is based on a plurality of the recordings in the set of recordings.

2. Method according to claim 1, wherein the data representative of the user profile (7; 17,19,29) includes data representative of the distribution over the plurality of recordings in the set of recordings of parameter values obtained by applying the pre-determined analysis algorithm to the signals representing at least sections of the respective recordings.

3. Method according to claim 2, including applying a clustering algorithm to the parameter values obtained by applying the predetermined analysis algorithm to the signals representing at least sections of the respective recordings, and including in the data representative of the user profile (7;17,19,29) data indicating the position of the clusters (10-12) along at least one quantified dimension of the feature space.

4. Method according to claim 2, wherein the data representative of the user profile (7;17,19,29) includes data indicating the strength of each cluster (10-12).

5. Method according to claim 2, wherein the data representative of the user profile (7;17,19;29) includes data indicating the spread of each cluster (10-12) along at least one quantified dimension of the feature space.

6. Method according to claim 1, wherein at least one further set of parameter values, each set containing at least one parameter value and quantifying at least one further dimension of the feature space, is obtained by applying at least one predetermined analysis algorithm to each of a plurality of signals, each signal representing at least a section of a recording of at least one perceptible content element in the set of recordings,
wherein at least one measure of a correlation between parameter values quantifying different dimensions of the feature space is determined, and
wherein data representative of the determined measures is included among the data representative of the user profile.

7. Method according to claim 1, including determining the items of content associated with the user on the basis of a user's selection of the items of content for processing by the user device.

8. Method of filtering a user profile (7;17,19;29) of a user of a device for processing data representative of items (1;30) of content, a respective recording of at least one perceptible content element being associated with each item of content, including
determining a set containing at least one recording of at least one perceptible content element, respectively associated with items of content associated with the user,
generating data representative of a user profile indicating preferences of the user, wherein the data representative of the user profile (7;17,19;29) includes one or more parameter values within an at least one-dimensional feature space, each dimension representing a property of at least a section of a recording of a perceptible content element, such that at least one of the dimensions in the feature space represents a quantifiable property of at least a section of a recording of a perceptible content element the audio track, and transmitting the data representative of the user profile (7;17,19;29) to a second device arranged to determine, using a similarity metric, whether any of one or more further profiles including a set of one or more parameter values within the feature space match the user profile (7;17,19;29), characterised in that
at least one set of at least one parameter value quantifying a dimension of the feature space in the user profile (7;17,19;29) is obtained by applying a pre-determined analysis algorithm to at least one signal representing at least a section of a recording of at least one perceptible content element in the set of audio tracks.

9. Method according to claim 8 wherein the user profile (7;17,19;29) is obtained by applying a method of generating a user profile (7;17,19;29) of a user of a device (14,15;23-26) for processing data representative of items of content, a respective recoding of at least one perceptible content element being associated with each item of content, including
determining a set (3) containing a plurality of recordings of at least one perceptible content element, each associated with one of a plurality of items of content associated with the user, and
generating data representative of a user profile (7;17,19;29) indicating preferences of the user, wherein the data representative of the user profile (17;17,19;29) includes one or more parameter values within an at least one-dimensional feature space, each dimension representing a property of at least a section of a recording of a perceptible content element, such that at least one of the dimensions in the feature space represents a quantifiable property of at least a section of a recording of a perceptible content element, characterised in that
at least one set of parameter values, each set containing at least one parameter value and quantifying a dimension of the feature space in the user profile (7;17,19;29), is obtained by applying a pre-determined analysis algorithm to each of a plurality of signals, each signal representing at least a section of a recording of at least one perceptible content element, such that the set of parameter values is based on a plurality of the recordings in the set of recordings.

10. Method of filtering a user profile (7; 17,19;29) expressing preferences of a user of a device (14,15;23-26) for processing data representative of items (1;30) of content having respective recordings of at least one perceptible content element associated with them, including
generating data representative of a user profile indicating preferences of the user, wherein the data representative of the user profile (17;29) includes one or more parameter values within an at least one-dimensional feature space, each dimension representing a property of at least a section of a recording of a perceptible content element, such that at least one of the dimensions in the feature space represents a quantifiable property of at least a section of a recording of a perceptible content element, and determining, using a similarity metric, whether any of one or more further profiles (19;37) including a set of one or more parameter values within the feature space match the user profile, wherein the data representative of the user profile (7;17,19;29) is generated by applying a method according to claim 1.

11. Method of filtering a user profile (7;17,19;29) expressing preferences of a user of a device (14,15;23-26) for processing data representative of items of content having respective recordings of at least one perceptible content element associated with them, wherein
a second device (14,15;23-27) receives from the device (14,15;23-26) through a data link (16;28) data representative of a user profile (7;17,19;29) indicating preferences of the user, wherein the data representative of the user profile (7;17,19;29) includes one or more parameter values within an at least one-dimensional feature space, each dimension representing a property of at least a section of a recording of a perceptible content element, wherein at least one of the dimensions in the feature space represents a quantifiable property of at least a section of a recording of a perceptible content element, and wherein
the second device retrieves one or more further profiles (19;37) including a set of one or more parameter values within the feature space and determines, using a similarity metric, whether any of the retrieved profiles matches the user profile, characterised in that
the second device (14,15;23-27) receives and determines whether any of the retrieved profiles matches a user profile in which at least one of the parameter values is obtainable by applying a pre-determined analysis algorithm to at least one signal representing at least a section of a recording in the set of recordings.

12. Method of filtering a user profile according to claim 8, wherein the further profiles are formed by further user profiles (37), each expressing the preferences of a further user of a device (22-26) for processing data representative of items (30) of content having respective audio tracks associated with them, including identifying further users having a further user profile (37) matching the user profile (29).

13. Method according to claim 12, including, for each further user having a further user profile (37) matching the user profile (29), retrieving a list (39) of content items selected by that further user, and
generating a list of recommended content items for the user, wherein the recommended content items are selected from the retrieved lists (39) of content items.

14. System for generating a user profile, configured to execute a method according to claim 1.

15. System for filtering a user profile, configured to execute a method according to claim 8.

16. Computer program including a set of instructions capable, when incorporated in a machine-readable medium, of causing a system (14,15,22-27) having information processing capabilities to perform a method according to claim 1.
